(19) United States
(12) Patent Application Publication
(10) Pub. No.: US 2009/0198885 A1
(43) Pub. Date: Aug. 6, 2009

(54) SYSTEM AND METHODS FOR HOST SOFTWARE STRIPE MANAGEMENT IN A STRIPED STORAGE SUBSYSTEM

(76) Inventor: Jose K. Manoj, Lilburn, GA (US)

Correspondence Address: Duft Bornsen & Fishman LLP, 1526 Spruce Street, Suite 302, Boulder County, CO, 80302, US

(21) Appl. No.: 12/025,211

(22) Filed: Feb. 4, 2008

(51) Int. Cl. G06F 12/00

(52) U.S. Cl. 711/114; 711/E12.001

(57) ABSTRACT

Systems and methods for coalescing host generated write requests in a RAID software driver module to generate full stripe write I/O operations to storage devices. Where RAID management is implemented exclusively in software features and aspects hereof improve performance by using full stripe write operations instead of slower read-modify-write operations. The features and aspects may be implemented for example within a software RAID driver module coupled to a plurality of storage devices in a storage system devoid of RAID specific hardware and circuits.

### BACKGROUND

1. Field of the Invention

The invention relates to storage systems and more specifically relates to host based software RAID storage management of a striped RAID volume where the stripe management is performed in a software driver module of a host system attached to the storage subsystem.

2. Discussion of Related Art

Redundant Arrays of Independent/Inexpensive Disks (RAID) systems are disk array storage systems designed to provide large amounts of data storage capacity, data redundancy for reliability, and fast access to stored data. RAID provides data redundancy to recover data from a failed disk drive and thereby improve reliability of the array. Although the disk array includes a plurality of disks, to the user the disk array is mapped by RAID management techniques to appear as one large, fast, reliable disk.

There are several different methods to implement RAID. RAID level 1 mirrors the stored data on two or more disks to assure reliable recovery of the data. RAID level 5 or 6 is a common architecture in which blocks of data are distributed (“striped”) across the disks in the array and a block (or multiple blocks) of redundancy information (e.g., parity) are also distributed over the disk drives with each “stripe” consisting of a number of data blocks and one or more corresponding redundancy (e.g., parity) blocks. Each block of the stripe resides on a corresponding disk drive.

RAID levels 5 and 6 may suffer I/O performance degradation due to the number of additional read and write operations required in data redundancy algorithms. Most high performance RAID storage systems therefore include a RAID controller with specialized hardware and circuits to assist in the parity computations and storage. Such RAID controllers are typically embedded within the storage subsystem but may also be implemented as specialized host bus adapters (“HBA”) integrated within a host computer system.

In such a striped RAID system (e.g., RAID level 5 or 6) there are two common write methods implemented to write new data and associated new parity to the disk array. The two methods are the Full Stripe Write method and the Read-Modify-Write method also known as a partial stripe write method. If a write request indicates that only a portion of the data blocks in any stripe are to be updated then the Read-Modify-Write method is generally used to write the new data and to update the parity block of the associated stripe. The Read-Modify-Write method involves the steps of: 1) reading into local memory old data from the stripe corresponding to the blocks to be updated by operation of the write request, 2) reading into local memory the old parity data for the stripe, 3) performing an appropriate redundancy computation (e.g., a bit-wise Exclusive-Or (XOR) operation to generate parity) using the old data, old parity data, and the new data, to generate a new parity data block, and 4) writing the new data and the new parity data block to the proper data locations in the stripe. By contrast a Full Stripe Write operation provides all the data and redundancy blocks of a stripe to the disk drives in a single I/O operation thus saving the time required to read old data and old redundancy information for purposes of computing new redundancy information.

While high performance striped RAID storage subsystems typically include specialized hardware circuits in a dedicated storage controller to attain desired levels of performance, lower cost RAID management may be performed by software elements operable within a user's personal computer or workstation. Thus, reliability of RAID storage management techniques may be provided even in a low end, low cost, personal computing environment. Although performance of such a software RAID implementation can never match the level of high performance RAID storage subsystems utilizing specialized circuitry and controllers, it is an ongoing challenge for low cost software RAID management implementation to improve performance.

### SUMMARY

The present invention improves upon past software RAID management implementations, thereby enhancing the state of the useful arts, by providing systems and methods for coalescing one or more portions of one or more host generated write requests to form a full stripe write operations for application to the disk drives.

One aspect hereof provides a method operable in a software driver within a host system coupled to a storage subsystem by a communication medium. The method includes receiving in the software driver a plurality of host generated write requests generated by one or more programs operating on the host system. The method then coalesces, within the software driver, portions of one or more of the plurality of host generated write requests to generate a full stripe of data for application to the storage devices of the storage subsystem. The method then writes the full stripe I/O write request to the storage devices via the communication medium between the host system and the storage subsystem to store a full stripe of data using a single write request to the storage devices.

Another aspect hereof provides a method of performing application generated sequential write requests directed to a striped RAID volume stored in a storage subsystem having multiple storage devices. The method includes receiving a plurality of host generated write requests within a software RAID driver module wherein the software RAID driver module operates within the same host system that generates the host generated write requests. The method then splits each host generated write request at stripe boundaries of the striped RAID volume to generate multiple internal packets within the software RAID driver module. The method then coalesces one or more internal packets associated with an identified stripe of the striped RAID volume to form a full stripe of data. The method then writes the full stripe of data to the identified stripe of the storage subsystem.

### BRIEF DESCRIPTION OF THE DRAWINGS

FIG. 1 is a block diagram of a system utilizing a software RAID management module enhanced in accordance with features and aspects hereof operable within a host system that also provides the underlying host request generation.

FIG. 2 is a diagram representing exemplary coalescing of host generated write requests to form full stripe write requests to be applied to disk drives of the system in accordance with features and aspects hereof.

FIG. 3 is a flowchart describing an exemplary method in accordance with features and aspects hereof to coalesce host generated write requests for purposes of generating more efficient full stripe write requests in accordance with features and aspects hereof.

### DETAILED DESCRIPTION OF THE DRAWINGS

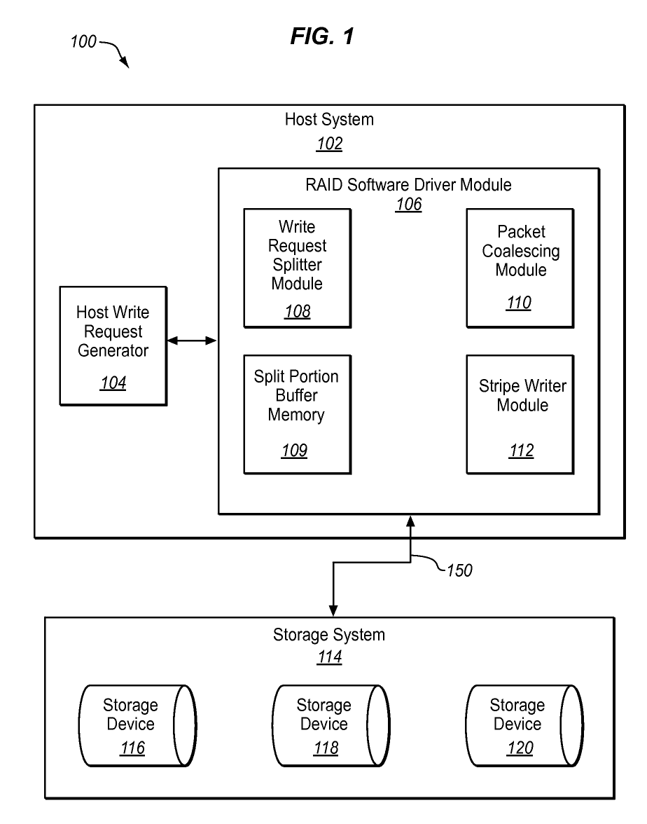

FIG. 1 is a block diagram of a system 100 including a host system 102 in which a software RAID management driver module 106 is operable in accordance with features and aspects hereof. Host system 102 may be a personal computer or workstation as generally known in the art. System 102 is coupled via communication medium 150 to storage system 114 comprising a plurality of storage devices (e.g., disk drives) 116, 118, and 120. Communication medium 150 may provide any suitable medium and protocol for exchanging information between host system 102 and storage system 114 through RAID software driver module 106. For example, storage system 114 may simply provide a plurality of disk drives (116 through 120) plugged directly into a bus adapter of the host system 102 and physically housed and powered by common structures of host system 102. Thus communication medium 150 may simply represent an internal bus connection directly between host system 102 and storage system 114 such as through a PCI bus or a host bus adapter coupling the disk drives via IDE, EIDE, ATA, SCSI, SAS, SATA, etc. In addition, communication medium 150 may represent a suitable external coupling between the host system 102 and a physically distinct and powered storage system 114. Such a coupling may include SCSI, Fibre Channel, or any other suitable high speed parallel or serial connection communication medium and protocol.

Of note in the configuration of system 100 is the fact that storage system 114 is largely devoid of any storage management capability for providing RAID storage management or even striping storage management devoid of RAID redundancy. Thus, RAID software driver module 106 is a software module (e.g., a driver module) operable within host system 102 for providing RAID management of stripes and redundancy information for a RAID volume on storage system 1/14.

Host write request generator 104 generates write requests to be forwarded to RAID software driver module 106. Host write request generator 104 may thus represent any appropriate application program, operating system program, file or database management programs, etc. operating within host system 102. Further, host write request generator 104 may represent any number of such programs all operating concurrently within host system 102 all operable to generate write requests.

Typically in such host write requests, the data to be written is generally provided in sizes and directed to logical addresses within the RAID volume useful for the particular application or operating system purpose. Thus, the particular size of the data for each write request may be any suitable size appropriate to the generating program regardless of optimal sizes useful in optimizing storage of data on the disk drives of storage system 114. Further, the data to be written in each sequential host write request may be directed to sequential logical addresses on the RAID volume.

RAID software driver module 106 includes a write request splitter module 108 adapted to receive host generated write requests from generator 104 and operable to split the data of such a host generated write request into one or more portions (“packets”) corresponding to be used as internally generated write requests of the RAID software driver module 106. Such portions/packets need not be buffered or cached (beyond the buffering used to hold the data as received in the host generated write request). Splitter module 108 is generally operable to identify where in the data of a host generated write request a stripe boundary would be located if the data were to be written to storage system 114. Where any such stripe boundary is identified in the data of a host generated write request, splitter module 108 subdivides the data at that point and generates a first internally generated write request (portion/packet) corresponding to the initial portion preceding the identified stripe boundary and a second internally generated write request (portion/packet) corresponding to the remainder of the data of the host generated ride request. The splitter module then continues analyzing that remaining portion to determine if still other stripe boundaries may be present.

Packet coalescing module 110 within RAID software driver module 106 analyzes such portions/packets split out from the data of a host generated write request to identify portions associated with an identified stripe of the storage system 114. When a sufficient number of portions/packets are identified associated with a particular identified stripe of the RAID volume stored in storage system 114, module 110 coalesces such portions into a single internally generated write request ready for

Those of ordinary skill in the art readily recognize a variety of additional and equivalent elements that may be resident in a host system 102 and storage system 114 to provide complete functionality. Such additional and equivalent elements are readily known to those of ordinary skill in the art and omitted from FIG. 1 merely for simplicity and brevity of this discussion.

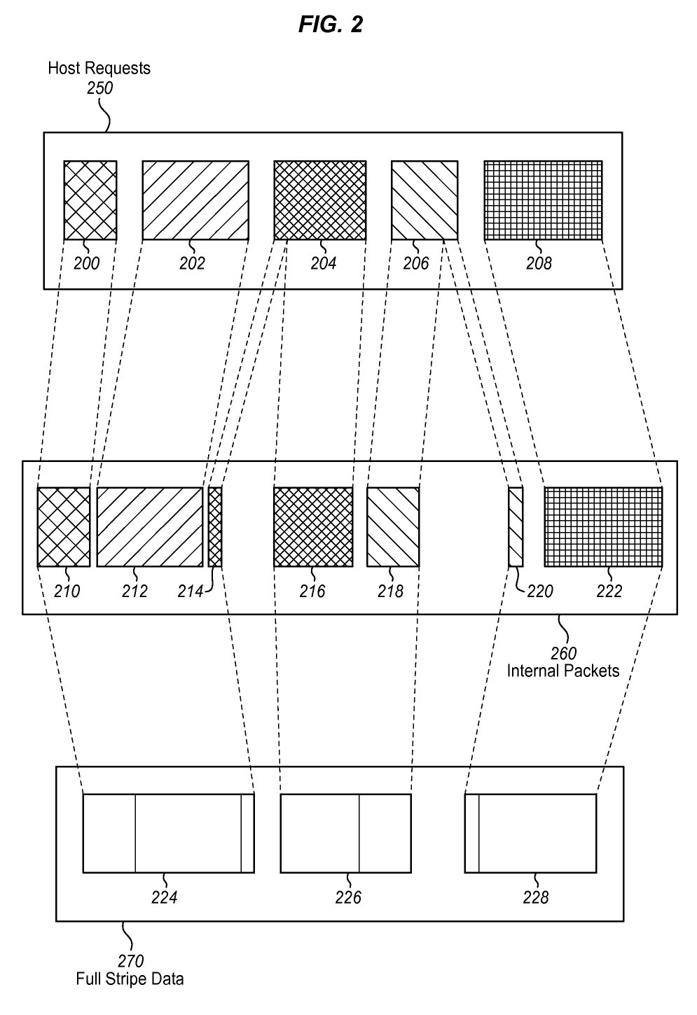

FIG. 2 is a diagram describing exemplary operation within a system such as that shown above in FIG. 1 to coalesce one or more portions/packets of a plurality of host generated write requests to generate more efficient full stripe write I/O operations for application to the storage devices of a storage subsystem. Exemplary host requests 250 include host generated write requests 200, 202, 204, 206, and 208. Each host generated write request will be directed to some position within a stripe in accordance with the logical address and parameters provided in the host generated write request. The particular exemplary host generated write requests 250 may be received by the software RAID driver module and thus may be held within the software RAID driver module until suitable coalescing of requests is possible to provide full stripe write I/O operations to the storage devices. For example, neither request 200 nor the next sequential request 202 is sufficient to completely fill a full stripe 224 (as discussed further below). Thus requests 200 and 202 are held in the buffers in which they are received until such time as a next sequential write request 204 is received to complete the full stripe 224.

Further, the particular sizes of the exemplary host requests 250 may be any suitable size appropriate to the particular generator programs but in general will not necessarily correspond to the size of any particular stripe in the storage system. Those of ordinary skill in the art will readily recognize that the buffer containing the host supplied write data may simply be utilized in conjunction with suitable meta-data constructs to identify portions/packets to be coalesced from the buffers in which the data was received. Still further, those of ordinary skill in the art will recognize that such meta-data may be implemented as a well known scatter/gather list suitable for DMA or RDMA access directly to the storage devices of the storage subsystem. Such design choices will be readily apparent to those of ordinary skill in the art.

A first aspect of the coalescing process of system 100 of FIG. 1 is operation of a splitter module to split each received host generated write request into one or more portions/packets (internal packets 260). Host generated write request 200 as exemplified in FIG. 2 may coincidentally start at the beginning location of a stripe boundary. Thus internal packet 210 may simply represent the entirety of the host generated write request 200. Another host generated write request 202 happens to start at a location abutting the ending location of internally generated packet 210 but does not fully fill the stripe. Thus internally generated packet 212 may also represent the entirety of host generated write request 202 positioned as desired within a particular stripe. By contrast, host generated write request 204 has a first portion in one stripe and its remaining portion in a different stripe (a sequentially next stripe of the RAID volume). Thus host generated write request 204 is split into two internally generated packets 214 and 216. Internally generated packet 214 is of such a length as to fill a first stripe in combination with internally generated packets 210 and 212. Thus, full stripe 224 of full stripe data 270 is comprised of internally generated packets 210, 212, and 214. The remaining portion of hosted generated write request 204 then forms the beginning portion of a new stripe as internally generated packet 216. Host generated write request 206, like request 204, has a first portion split therefrom as internally generated packet 218 to complete a second stripe. Thus internally generated packet 216 and 218, representing a portion of host generated request 204 and a portion of host generated request 206 comprise full stripe 226 in full stripe data 270. The remaining portion of host generated write request 206 forms a beginning portion of a new stripe represented as internally generated packet 220. The entirety of host generated write request 208 coincidentally completes the next stripe and thus internally generated packet 222 represents the entirety of host generated write request 208. Internally generated packet 220 and 222 therefore form full stripe 228 within full stripe data 270.

Thus as shown in FIG. 2, an exemplary sequence of host generated write requests 200 through 208 are coalesced by first splitting host generated write requests as necessary to generate internally generated packets 210 through 222. The internally generated packets are then combined or coalesced to form three full stripes 224 through 228. Such full stripes may then be written to the storage devices of the storage subsystem to thereby improve efficiency in writing to a RAID volume managed solely by RAID software driver modules as compared to prior techniques which would have performed time consuming read-modify-write operations for each host generated write request.

Those of ordinary skill in the art will readily recognize a variety of sequences of host generated write requests that may be split into portions/packets as required and then combined or coalesced to form full stripes. The particular size, location, and order of receipt of host generated write requests 200 through 208 is therefore intended merely as exemplary of one possible utilization of systems and methods in accordance with features and aspects hereof.

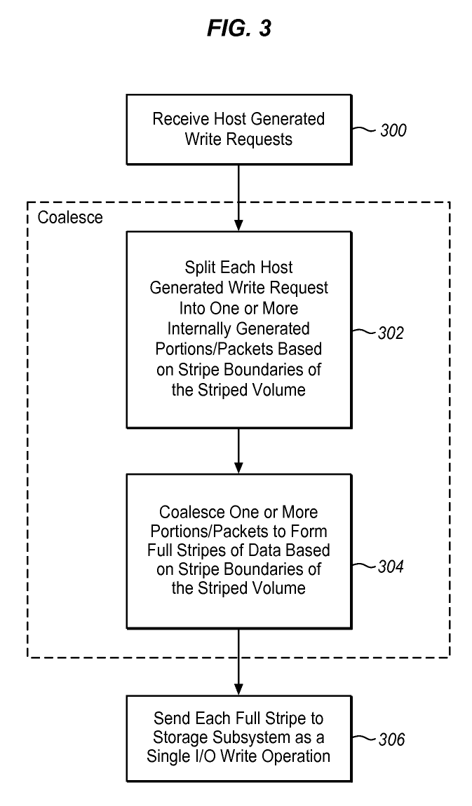

FIG. 3 is a flowchart describing an exemplary method in accordance with features and aspects hereof. The method of FIG. 3 is operable within a RAID software management module, such as a RAID software driver module, operable in a host system. Step 300 represents receipt of host generated write requests from application programs or operating system and file management programs operable in the same host system in which the method of FIG. 3 is operable as a software RAID management driver module. Steps of 302 and 304 then represent coalescing operation to combine one or more portions of one or more of the received host generated write requests to create more efficient full stripe data to be written to the storage devices of the storage system. In general, steps 300, 302, and 304 may be continually operable substantially concurrently such that receipt of generated host generated write requests provides a data stream to be analyzed and coalesced by concurrent operation of steps 302 and 304. Also as noted above, where the host generated write requests are generally sequential in nature, the operation of steps 300 through 304 may be operable essentially sequentially such that each host generated write request is split at stripe boundaries and coalesced to form full stripe write I/O operations as it is received.

The coalescing of steps 302 and 304 generally includes splitting each host generated write request into one or more internally generated portions/packets based on stripe of boundaries of the striped RAID volume stored on the storage devices. Step 302 identifies such stripe boundaries within each received host generated write request and splits the data of the write request into one or more internally generated portions/packets. Step 304 coalesces one or more such identified portions/packets to form one or more full stripes of data based on the stripe size and stripe boundaries associated with the striped RAID volume stored on the storage devices. As noted above, in a preferred embodiment, the data received with a host generated write request need not be specifically copied or buffered to perform the splitting and coalescing of steps 302 and 304. Rather, meta-data structures including, for example, scatter/gather lists may be constructed to logically define the data comprising a full stripe as portions/packets of the received host generated write request data. Such design choices will be readily apparent to those of ordinary skill and the art.

Having thus formed one or more full stripes of data, step 306 then transfers or writes each full stripe created to the storage subs subsystem. Each full stripe write will thus comprise a single I/O write operation to provide the entirety of the full stripe to the storage devices of the storage system. Those of ordinary skill in the art will readily recognize that depending upon the particular RAID storage management to be provided, redundancy information such as parity blocks may be generated in conjunction with the full stripe of data to form a full stripe including such redundancy or parity information. Thus the coalescing of portions of one or more host to generated write requests to generate full stripe I/O write operations on the storage devices improves performance as compared to prior systems and techniques implemented in host system software where more time consuming read-modify-write operations need be performed to store host generated write request data on a RAID volume.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A method operable in a software driver within a host system coupled to a storage subsystem by a communication medium, the method comprising
receiving in the software driver a plurality of host generated write requests generated by one or more programs operating on the host system;
coalescing, within the software driver, portions of one or more of the plurality of host generated write requests to generate a full stripe of data for application to the storage devices of the storage subsystem; and
writing the full stripe I/O write request to the storage devices via the communication medium between the host system and the storage subsystem to store a full stripe of data using a single write request to the storage devices.

2. The method of claim 1 wherein the step of coalescing further comprises:
splitting each host generated write request into one or more internally generated write requests within the software driver each internally generated write request representing a portion of one of the host generated write requests.

3. The method of claim 2 wherein the step of coalescing further comprises:
coalescing one or more internally generated write requests to generate the full stripe of data.

4. The method of claim 1 wherein a striped RAID volume is stored on the storage subsystem,
wherein the step of coalescing further comprises coalescing said portions where said portions are all stored within the same identified stripe of the striped RAID volume, and
wherein the step of writing further comprises writing the full stripe of data to the identified stripe.

5. A method of performing application generated sequential write requests directed to a striped RAID volume stored in a storage subsystem having multiple storage devices, the method comprising:
receiving a plurality of host generated write requests within a software RAID driver module wherein the software RAID driver module operates within the same host system that generates the host generated write requests;
splitting each host generated write request at stripe boundaries of the striped RAID volume to generate multiple internal packets within the software RAID driver module;
coalescing one or more internal packets associated with an identified stripe of the striped RAID volume to form a full stripe of data; and
writing the full stripe of data to the identified stripe of the storage subsystem.

6. The method of claim 5
wherein the step of splitting further comprises:
generating a packet meta-data structure for each location within a data portion of each host generated write request that crosses a boundary of a stripe of the RAID striped volume.

7. The method of claim 6
wherein the step of coalescing further comprises:
using the meta-data structures to identify one or more internal packets that comprise said identified stripe.

8. The method of claim 5
wherein the step of coalescing further comprises:
generating a scatter/gather list for said identified stripe that identifies one ore more internal packets that comprise said identified stripe.

9. A system comprising:
a host system;
a storage subsystem having a plurality of storage devices; and
a communication medium coupling the host system to the storage subsystem, the host system including:
software driver means adapted to receive a plurality of host generated write requests generated by one or more programs operating on the host system;
coalescing means, within the software driver means, adapted to coalesce portions of one or more of the plurality of host generated write requests to generate a single full stripe of data for application to the storage devices of the storage subsystem; and
writing mean, within the software driver means, for writing the full stripe I/O write request to the storage devices via the communication medium between the host system and the storage subsystem to store a full stripe of data using a single write request to the storage devices.

10. The system of claim 9 wherein the coalescing means further comprises:
means for splitting each host generated write request into one or more internally generated write requests within the software driver each internally generated write request representing a portion of one of the host generated write requests.

11. The system of claim 10 wherein the coalescing means further comprises:
means for coalescing one or more internally generated write requests to generate the full stripe of data.

12. The system of claim 9 wherein a striped RAID volume is stored on the storage subsystem,
wherein the coalescing means further comprises means for coalescing said portions where said portions are all stored within the same identified stripe of the striped RAID volume, and
wherein the writing means further comprises means for writing the full stripe of data to the identified stripe.

13. A system comprising:
a storage subsystem on which is stored a striped RAID volume;
a communication medium coupled to the storage subsystem;
a host system coupled to the communication medium for exchanging information with the storage subsystem, the host system including:
a write request generator for generating host write requests for storage on a RAID storage volume; and
a software driver module coupling the host system to the storage subsystem through the communication medium and coupled to the write request generator to receive host write requests, the software driver module including:
a write request splitter module for splitting the data of each received host write request to form one or more internal packets within the software driver module wherein the splitter module is adapted to split each host write request into one or more internal packets at boundaries corresponding to stripe boundaries of the striped RAID volume;
a packet coalescing module coupled to the write splitter module to coalesce one or more internal packets, each associated with an identified stripe of the striped RAID volume, to form a full stripe of data representing the identified stripe; and
a stripe writer module coupled to the packet coalescing module for writing the full stripe of data to the identified stripe of the striped RAID volume.
